(19) United States
(12) Patent Application Publication
(10) Pub. No.: US 2024/0262452 A1
(43) Pub. Date: Aug. 8, 2024

(54) FRAME BRACE FOR A DIRT BIKE

(71) Applicant: Avail Motorsports, LLC, Columbus, OH (US)

(72) Inventor: Andrew Farkas, Columbus, OH (US)

(21) Appl. No.: 18/435,465

(22) Filed: Feb. 7, 2024

Related U.S. Application Data
(60) Provisional application No. 63/443,862, filed on Feb. 7, 2023.

(51) Int. Cl. B62K 11/02

(52) U.S. Cl. CPC B62K 11/02

(57) ABSTRACT

A brace for strengthening a connection between an engine and a frame of a motorcycle includes a body that is configured to overlie the engine. The body has a first mounting hole and a second mounting hole in spaced relationship with one another. The first and second mounting holes are configured to be aligned with mounting holes of the engine and frame for receiving bolts to connect the brace, the engine and the frame to one another. A rear anchor extends perpendicularly from the body for overlying and engaging a portion of the frame.

### CROSS REFERENCE TO RELATED APPLICATIONS

This utility patent application claims the benefit of U.S. provisional patent application Ser. No. 63/443,862, filed on Feb. 7, 2023, the entire disclosure of which is hereby incorporated by reference in its entirety.

### FIELD OF THE DISCLOSURE

The present disclosure relates to motorcycles, such as dirt bikes. More particularly, the present disclosure relates to a brace for reinforcing a connection between a frame and an engine of a motorcycle.

### BACKGROUND

This section provides background information related to the present disclosure which is not necessarily prior art.

It is known for dirt bikes to utilize rider pegs (foot pegs) for supporting a rider's feet. Rider pegs are often connected to a lower region of an engine housing. The connection of the engine housing to the frame is typically comprised of only three bolts, which can be unsatisfactorily weak, especially when a rider's full weight is on the rider pegs. Moreover, frames can be inherently weak due to an absence of an engine cradle. Accordingly, there remains a need for improvements to engine and frame arrangements for motorcycles.

### SUMMARY OF THE INVENTION

According to an aspect of the disclosure, a brace for strengthening a connection between an engine and a frame of a motorcycle includes a body that is configured to overlie the engine. The body has a first mounting hole and a second mounting hole in spaced relationship with one another. The first and second mounting holes are configured to be aligned with mounting holes of the engine and frame for receiving bolts to connect the brace, the engine and the frame to one another. A rear anchor extends perpendicularly from the body for overlying and engaging a portion of the frame.

According to another aspect of the disclosure, a motorcycle includes a frame that has a plurality of frame mounting holes. An engine is coupled to the frame. The engine includes a plurality of engine mounting holes each aligned with one of the frame mounting holes. A brace is coupled to the engine and the frame for strengthening a connection between the engine and the frame. The brace includes a body that overlies the engine and has a first brace mounting hole aligned with one of the frame mounting holes and one of the engine mounting holes, and a second brace mounting hole in spaced relationship with the first brace mounting hole and aligned with one of the frame mounting holes and one of the engine mounting holes. A pair of bolts are each received by one of the first and second brace mounting holes and aligned frame and engine mounting holes to connect the brace, the engine and the frame to one another. A rear anchor extends perpendicularly from the body for overlying and engaging a portion of the frame.

The brace reinforces attachment points of the motorcycle's engine to its frame, increases a clamping area of engine bolts to the frame, and anchors the engine to the frame to prevent pull-out of the engine. The brace provides these benefits with a simple, cheap and easy to fabricate structure.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is front view of a right frame brace according to an aspect of the disclosure;

FIG. 2 is a rear view of the right frame brace;

FIG. 3 is a front view of a left frame brace according to an aspect of the disclosure;

FIG. 4 is a rear view of the left frame brace; and

FIG. 5 is a front view of an arrangement of an engine and frame of a motorcycle with the right and left braces coupled to the engine and frame to reinforce a connection between the engine and frame.

### DESCRIPTION OF THE EXAMPLE EMBODIMENTS

Referring to the figures, wherein like numerals indicate corresponding parts throughout the several views, braces 10, 12 for reinforcing a connection between a frame 14 and engine 15 of a motorcycle such as a dirt bike 16 are provided. An example of a dirt bike that the subject frame braces 10, 12 could be connected to is a 2019+ Honda® CRF110. It should be appreciated that the teachings of the present disclosure could be applied to other styles of motorcycles.

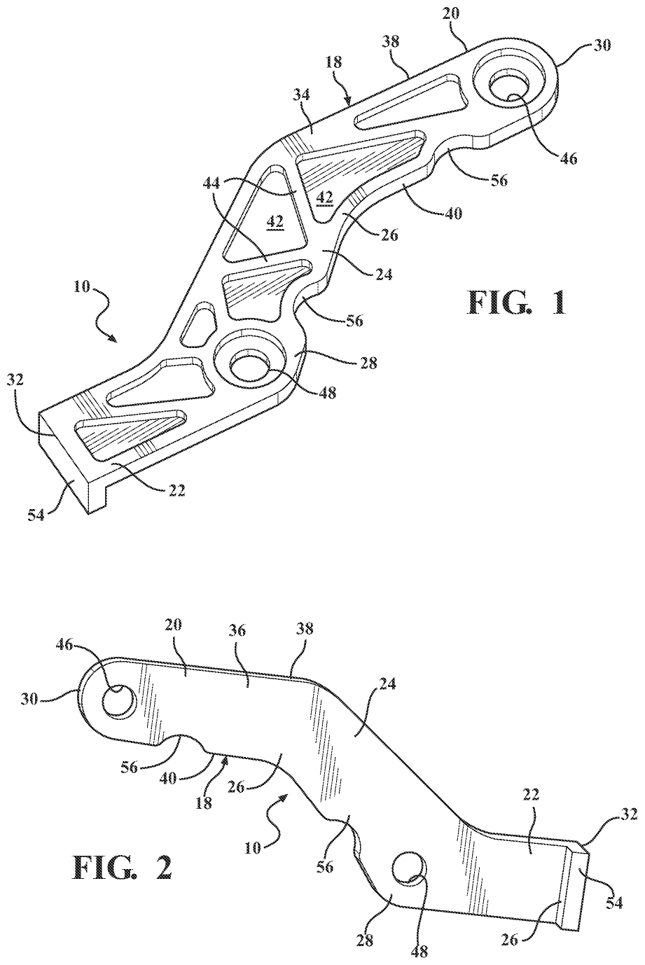

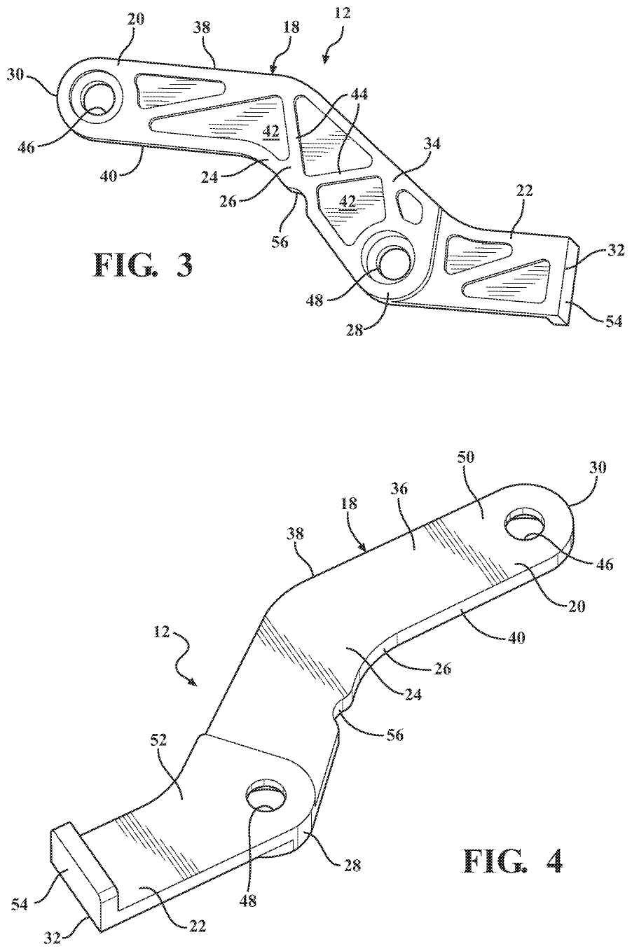

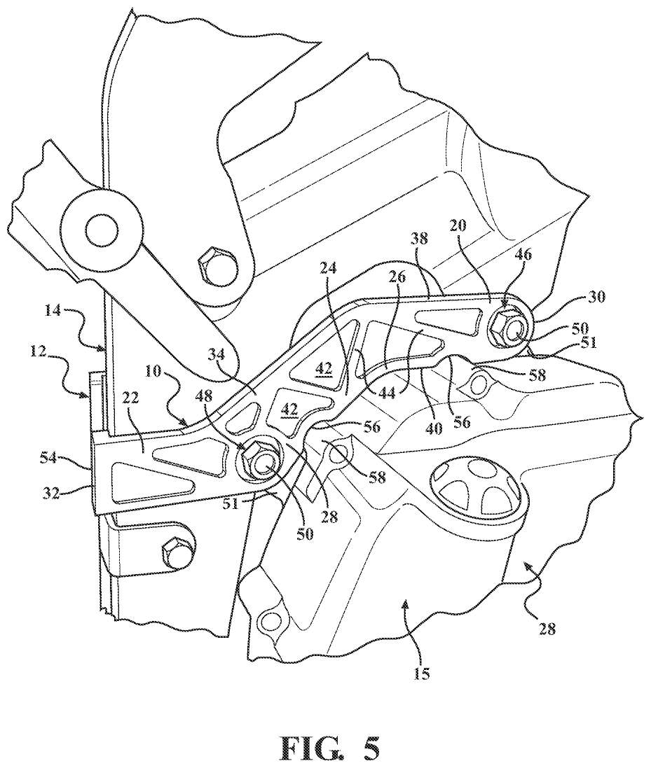

FIGS. 1-2 present an embodiment of a right brace 10, and FIGS. 3-4 present an embodiment of a left brace 12. The right and left braces 10, 12 are configured to be positioned on right and left sides of the frame 14, respectively, as shown in FIG. 5. According to the example embodiment, the right and left braces 10, 12 are mostly mirror images of one another, but some variations are present. According to the preferred embodiment, each of the braces 10, 12 are approximately 6 mm thick and made of a stamped metal material such as steel. Other materials and manners of fabrication could be used without departing from the scope of the present disclosure.

Each of the braces 10, 12 has a body 18 that has first end portion 20 and a second end portion 22 that extend in generally spaced and parallel relationship with each other. A central portion 24 interconnects the first and second end portions 20, 22 and extends at an angle relative to the first and second end portions 20, 22. A first angled portion 26 is defined at a meeting of the first end portion 20 and the central portion 24. A second angled portion 28 is located at a meeting between the second end portion 22 and the central portion 24. The first end portion 20 terminates at a first edge 30 opposite the central portion 24. The second end portion 22 terminates at a second edge 32 opposite the central portion 24.

The body 18 has a front face 34 (FIGS. 1 and 3) and a rear face 36 (FIGS. 2 and 4) opposite the front face 34. The body 18 also has a top edge 38 and a bottom edge 40. The front face 34 defines a plurality of recesses 42 and a plurality of gussets 44 extending laterally between the recesses 42. The recesses 42 provide a weight reduction for the brace 10, 12 and the guests 44 laterally strengthen the brace 10, 12.

A first brace mounting hole 46 is located adjacent to the first edge 30. A second brace mounting hole 48 located adjacent to the second angled portion 28. As best shown in FIG. 5, the first and second brace mounting holes 46, 48 are configured to be aligned with engine mounting holes of the engine 15 and frame mounting holes of the frame 14. The first and second brace mounting holes 46, 48 and associated aligned engine and frame mounting holes are configured to receive bolts 50 which connect the engine, frame and brace to one another to provide a reinforcing effect. According to the preferred embodiment, the bolts 50 are stock bolts for the dirt bike 16. As shown, the mounting holes of the engine 15 may be located on flanges 51 that are part of the engine's 15 housing.

As shown in FIG. 4, the rear face 36 of the left brace 12 has a first planar portion 50 along the first end portion 20 and a protruded second planar portion 52 along the second end portion 22. The second planar portion 52 is positioned in spaced and parallel relationship with the first planar portion 50. The second planar portion 52 is configured to engage a first region of the frame 14 while providing an appropriate amount of spacing such that the first planar portion 50 engages a second portion of the frame 14. The second mounting hole 48 is located along the second planar portion 52.

According to both the right and left braces 10, 12, a rear anchor 54 extends from the second edge 32 of the second end portion 22 perpendicularly to the second end portion 22. As shown in FIG. 5, the rear anchor 54 serves as an additional attachment point on the rear of the frame 14 to secure the engine 15 further should the engine 15 become loose, thus preventing further damage to the frame 14 and frame mounts. Furthermore, the bottom edge 40 defines one or more recesses 56 for receiving bolt protrusions 58 (or other protruding features) of the engine 15 to conform the brace 10, 12 to a shape of the engine 15 to aid in positioning the brace 10, 12 in its proper position.

Additional anchors may be provided at other regions of the braces 10, 12 to accommodate attachments at other parts of the frame 14 and engine 15. Such anchors may be configured to receive fasteners to secure the brace 10, 12, frame 14 and engine 15 to one another.

Although the braces 10, 12 of the preferred embodiment are positioned on top of the engine 15, they could be located at other points of attachment between the engine 15 and frame 14.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The features of different embodiments described herein are combinable with one another even if not expressly discussed.

What is claimed is:

1. A brace for strengthening a connection between an engine and a frame of a motorcycle, comprising:
a body configured to overlie the engine and having a first mounting hole and a second mounting hole in spaced relationship with one another, wherein the first and second mounting holes are configured to be aligned with mounting holes of the engine and frame for receiving bolts to connect the brace, the engine and the frame to one another; and
a rear anchor extending perpendicularly from the body for overlying and engaging a portion of the frame.

2. The brace as set forth in claim 1, wherein the body has a bottom edge defining a at least one recess for receiving bolt protrusions on a top of the engine to conform the brace to a shape of the top of the engine.

3. The brace as set forth in claim 1, wherein the body has a first end portion and a second end portion extending in spaced and generally parallel relationship with one another and a central portion interconnecting the first and second end portions and extending at an angle relative to the first and second end portions.

4. The brace as set forth in claim 3, wherein a first angled portion is located at a meeting of the first end portion and the central portion, a second angled portion is located at a meeting between the second end portion and the central portion, wherein the first end portion terminates at a first edge opposite the central portion, the second end portion terminates at a second edge opposite the central portion, and wherein the first mounting hole is located adjacent to the first edge, and the second mounting hole located adjacent to the second angled portion.

5. The brace as set forth in claim 1, wherein the body has a front face and a rear face opposite the front face.

6. The brace as set forth in claim 5, wherein the front face defines a plurality of recesses for providing a weight reduction effect, and a plurality of gussets between the recesses for laterally strengthening the brace.

7. The brace as set forth in claim 5, wherein the rear face has a first planar portion along the first end portion and a protruded second planar portion, with the second planar portion extending in spaced and parallel relationship with the first planar portion.

8. The brace as set forth in claim 7, wherein the second mounting hole is located along the second planar portion.

9. A motorcycle, comprising:
a frame having a plurality of frame mounting holes;
an engine coupled to the frame, the engine including a plurality of engine mounting holes each aligned with one of the frame mounting holes;
a brace coupled to the engine and the frame for strengthening a connection between the engine and the frame;
the brace including a body overlying the engine and having a first brace mounting hole aligned with one of the frame mounting holes and one of the engine mounting holes, and a second brace mounting hole in spaced relationship with the first brace mounting hole and aligned with one of the frame mounting holes and one of the engine mounting holes;
a pair of bolts each received by one of the first and second brace mounting holes and aligned frame and engine mounting holes to connect the brace, the engine and the frame to one another; and
a rear anchor extending perpendicularly from the body for overlying and engaging a portion of the frame.
